(19) United States
(12) Patent Application Publication
(10) Pub. No.: US 2026/0281625 A1
(43) Pub. Date: Sep. 17, 2026

(54) LOUDSPEAKER AND VEHICLE AUDIO SYSTEM

(71) Applicant: SUZHOU SONAVOX ELECTRONICS CO., LTD., Suzhou, Jiangsu (CN)

(72) Inventors: Peng Gao, Suzhou, Jiangsu (CN); Zhanqing Dong, Suzhou, Jiangsu (CN); Zhenyu Tang, Suzhou, Jiangsu (CN); Minhua He, Suzhou, Jiangsu (CN); Hanyu Gu, Suzhou, Jiangsu (CN); Xiaofeng Ding, Suzhou, Jiangsu (CN)

(21) Appl. No.: 18/877,862

(22) PCT Filed: Nov. 18, 2022
(86) PCT No.: PCT/CN2022/132905

§ 371 Date: Dec. 20, 2024

(30) Foreign Application Priority Data
Aug. 9, 2022 (CN) 202210948550.0

(51) Int. Cl. H04R 9/04; H04R 1/02; H04R 1/06; H04R 7/12; H04R 9/02; H04R 9/06; H04R 31/00

(52) U.S. Cl. CPC H04R 9/043; H04R 1/023; H04R 1/06; H04R 7/127; H04R 9/025; H04R 9/06; H04R 31/006; H04R 2400/11; H04R 2499/13

(57) ABSTRACT

Disclosed are a loudspeaker and a vehicle audio system having the same. The loudspeaker includes: a frame; a cone having an outer end portion and an inner end portion that are open and opposite to each other, the frame being covered on the outer end portion of the cone, and the outer end portion being connected to the frame; a voice coil connected to the inner end portion of the cone; a magnetic drive unit to drive the voice coil to vibrate, the magnetic drive unit being arranged on the frame, the magnetic drive unit having a magnetic gap, and a part of the voice coil being inserted into the magnetic gap; and a spider arranged between the frame and the cone, and an outer edge of the spider being connected to the cone.

### CROSS-REFERENCE TO RELATED APPLICATIONS

This application is a National Stage Entry under 35 U.S.C. § 371 of International Application No. PCT/CN2022/132905, filed on Nov. 18, 2022, which claims priority from Chinese Patent Application No. CN 2022109485500 filed on Aug. 9, 2022. The disclosures of the aforementioned applications are hereby incorporated by reference in their entireties.

### TECHNICAL FIELD

The present disclosure relates the field of loudspeaker, in particular to an inverted loudspeaker and an vehicle audio system.

### BACKGROUND

As rapid developing of electronic technology, providing users with an excellent driving experience has become an important aspect of motor vehicles. Sound, as one of the three main in-vehicle interacting modes (sound, light, and touch), is particularly important in improving user experience. The vehicle audio systems usually comprise a plurality of loudspeakers, existing loudspeakers have various shapes and structures, the whole volume of the loudspeakers is large, and meanwhile, the space for installing loudspeakers in the vehicles is limited, reducing the height of loudspeakers (reducing the occupied space of loudspeakers) is an urgent technical problem that manufacturers need to solve.

At present, some vehicle audio systems may use inverted loudspeakers. For example, as shown in FIG. 5 and FIG. 6, the spider 6′ of this kind of inverted loudspeaker is provided outside the magnetic drive unit 5′ and the cone 2′, and has a larger volume. This inverted loudspeaker needs to use two frames 1′, with a dust screen 8, a magnetic drive unit 5′, a cone 2′ and a voice coil 4′ arranged between the two frames 1′, and holes are provided on the spider 6′ to connect leads 42′ and the spider 6′, which has a relatively high cost.

### SUMMARY

To solve the above technical problems, an object of the present disclosure is to provide a loudspeaker with a lower overall height, smaller space occupied and lower cost, and suitable for use as a loudspeaker adapted to be mounted in the door of vehicle.

Another object of the present disclosure is to provide an vehicle audio system, of which the loudspeakers occupy less space and save the space on the door of the vehicle.

A first aspect of the present disclosure provides an inverted loudspeaker including:
a frame;
a cone having an outer end portion and an inner end portion that are open and opposite to each other, the frame being covered on the outer end portion of the cone, and the outer end portion being connected to the frame;
a voice coil connected to the inner end portion of the cone;
a magnetic drive unit to drive the voice coil to vibrate, the magnetic drive unit being arranged on the frame, the magnetic drive unit having a magnetic gap, and a part of the voice coil being inserted into the magnetic gap;
the inverted loudspeaker further comprises:
a spider arranged between the frame and the cone, and an outer edge of the spider being connected to the cone.

Wherein, the frame is used to connect the cone, the spider and the magnetic drive unit.

In some embodiments, a center hole for exposing the magnetic gap is provided on a middle portion of the spider, and an inner edge surrounding the center hole of the spider is connected to the frame.

In some embodiment, the magnetic drive unit comprises a U-yoke, and a magnetic steel and a front panel arranged within the U-yoke, the magnetic gap is formed between an inner side surface of the U-yoke and outer side surfaces of the magnetic steel and the front panel, and the voice coil passes through the center hole and inserts into the magnetic gap.

In some embodiments, the frame has a cylindrical portion surrounding the U-yoke, and the inner edge of the spider is fixedly connected to the cylindrical portion of the frame.

In some embodiments, the inner edge of the spider is bonded to the cylindrical portion of the frame via glue.

In some embodiments, the cone comprises a conical body with a truncated conical shape, and the inner end portion is located at a cone top of the conical body; the outer end portion comprises a yoke ring connected to a cone bottom of the conical body, and the yoke ring is fixedly connected to the frame; and the outer edge of the spider is fixedly connected to an inner surface of the conical body.

In some embodiments, the inner end portion is a voice coil mounting hole located at the cone top, and the voice coil passes through the voice coil mounting hole and is bonded to a hole wall of the voice coil mounting hole.

In some embodiments, the voice coil has a lead connecting portion that passes through the voice coil mounting hole to the outside of the cone, and ends of leads of the voice coil are connected to the lead connecting portion.

In some embodiments, a wiring terminal is arranged on the frame, the wiring terminal comprises soldering lugs embedded in the frame, and the other ends of the leads are electrically connected to the soldering lugs respectively.

In some embodiments, the outer edge of the spider is bonded to the inner surface of the conical portion via glue.

In some embodiments, a part of the voice coil protrudes outside the cone, and the inverted loudspeaker further comprises a dustproof cover for covering the part of the voice coil protruding outside the cone.

In some embodiments, the frame comprises a main body and a skirt edge portion that is bent and extended from an outer edge of the main body, the cone is located in the space enclosed by the main body and the skirt edge portion, and the main body is provided with a plurality of hollowed-out portions for sound transmission.

In some embodiments, the main body comprises the above-mentioned cylindrical body and a plurality of connecting ribs. The plurality of connecting ribs are spaced along the perimeter of the cylindrical body, and each connecting rib extends outward along a diameter direction the cylindrical body. Each connecting rib gradually tilts upwards from its inner end to its outer end, and the above-mentioned hollowed-out portions are formed between every two adjacent connecting ribs.

In some embodiments, most part of the voice coil is also located within the above-mentioned space. Thus, the frame can provide good protection for internal components such as the cone and the voice coil.

In some embodiments, the skirt edge portion is provided with a wiring terminal, and the leads of the voice coil have inner end portions connected to the voice coil and outer end portions connected to the wiring terminal. The leads of the voice coil are relatively convenient to be connected and easy to assemble; and the leads do not need to be bent multiple times to avoid damage to the leads.

In some embodiments, the leads can be independently set with the spider, which eliminates the need for opening holes for the leads to pass through on the spider, thus simplifying assembly and greatly reducing production costs.

In some embodiments, the voice coil is provided with a plurality of through holes. The plurality of through holes are spaced along the perimetric direction of the voice coil, to facilitate heat dissipation.

A second aspect of the present disclosure provides an vehicle audio system including the inverted loudspeaker mentioned above.

In some embodiments, the inverted loudspeaker is mounted in the door of vehicle.

The present disclosure adopts the above solutions, and has the following advantages over conventional art:

In the inverted loudspeaker of the present disclosure, the spider is arranged between the cone and the frame, and the outer edge of the spider is connected to the cone, to form a structure where the spider is located between the cone and the magnetic drive unit, thereby reducing the overall height of the loudspeaker and making it more suitable for installation needs of some flat and narrow space structures, and meanwhile saving space for the door of vehicle, and only a single frame is required, the spider, the cone and the magnetic drive unit not only have a positioning voice coil function, but also can isolate dust and debris from entering the magnetic gap, without the need for a dust-proof cover.

### BRIEF DESCRIPTION OF THE DRAWINGS

For explaining the technical solutions in the embodiments of the present disclosure more clearly, the accompanying drawings used to describe the embodiments are simply introduced in the following. Apparently, the below described drawings merely show a part of the embodiments of the present disclosure, and those skilled in the art can obtain other drawings according to the accompanying drawings without creative work.

FIG. 1 is an exploded schematic diagram of an inverted loudspeaker of an embodiment of the present disclosure;

FIG. 2 is a top view of the inverted loudspeaker of an embodiment of the present disclosure;

FIG. 3 is a sectional cross view along Line A-A in FIG. 2;

FIG. 4 is a partial enlarged diagram of Part B in FIG. 2;

FIG. 5 is an exploded schematic diagram of another inverted loudspeaker;

FIG. 6 is a sectional cross view of another inverted loudspeaker;

wherein:
1′—frame; 2′—cone, 4′—voice coil; 42′—lead; 5′—magnetic drive unit; 6′—spider; 8—dust cover;
1—frame; 11—cylindrical portion; 12—wiring terminal; 121—soldering lug; 13—main body; 131—hollowed-out portion; 14—skirt edge portion; 2—cone; 21—outer end portion; 211—yoke ring; 22—inner end portion; 23—conical body; 4—voice coil; 41—lead connecting portion; 42—lead; 43—through hole; 5—magnetic drive unit; 51—magnetic gap; 52—U-yoke; 53—magnetic steel; 54—front panel; 6—spider; 61—outer edge; 62—center hole; 63—inner edge; 7—dust cover.

### DETAILED DESCRIPTION OF EXEMPLARY EMBODIMENTS

In the following, the preferable embodiments of the present disclosure are explained in detail combining with the accompanying drawings so that the advantages and features of the present disclosure can be easily understood by the skilled persons in the art. It should be noted that the explanation on these implementations is to help understanding of the present disclosure, and is not intended to limit the present disclosure. Further, the technical features involved in the various embodiments of the present disclosure described below may be combined with each other if they do not conflict with each other.

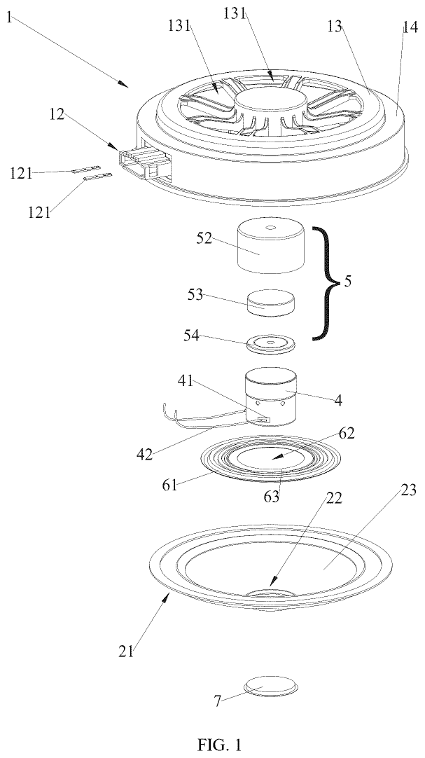

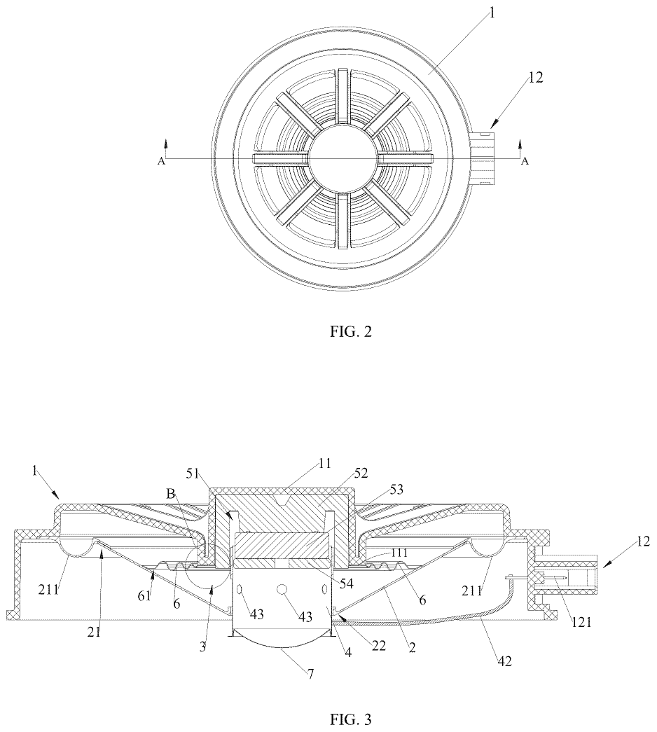

This embodiment provides an inverted loudspeaker. Referring to FIG. 1 to FIG. 3, the inverted loudspeaker comprises a frame 1, a cone 2, a voice coil 4, a magnetic drive unit 5, and a spider 6. Wherein, the frame 1 is bonded to the cone 2, and frame 1 is used to fix the cone 2, the magnetic drive unit 5, and the spider 6. When viewed from above, the inverted loudspeaker is overall circular.

Further, as shown in FIG. 3, the cone has an outer end portion 21 (specifically the upper end portion in FIG. 3) and an inner end portion 22 (specifically the lower end portion in FIG. 3) that are open and opposite to each other, with the outer end portion 21 bonded to the frame 1, and the inner end portion 22 bonded to the voice coil 4, and the frame 1 is covered on the outer end portion 21 of the cone 2; the voice coil 4 is glued to the inner end portion 22 of the cone 2; the magnetic drive unit 5 is used to drive the voice coil 4 to vibrate, the magnetic drive unit 5 is arranged on the frame 1, the magnetic drive unit 5 has a magnetic gap 51, and a part of the voice coil 4 is inserted into the magnetic gap 51; the spider 6 is arranged between the frame 1 and the cone 2, an outer edge 61 of the spider 6 is connected to the cone 2, more specifically, the cone 2 comprises a conical body 23 with a truncated conical shape, and the outer edge 61 of the spider 6 is bonded to the middle portion of the conical body 23, thereby reducing the overall height of the loudspeaker, occupying less space, and making it more suitable for installation needs of some flat and narrow space structures. Here, the orientation words “inner” and “outer defined with reference to the centerline of the center body of the loudspeaker (preferably coincides with the centerlines of the cone 2 and the voice coil 3), with the side closer to the centerline being considered as the inner, and the opposite as the outer.

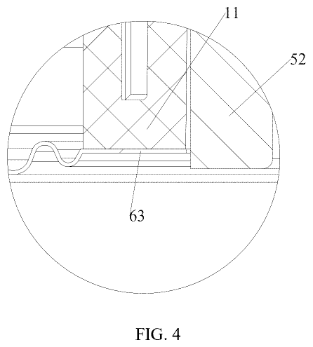

Referring to FIG. 1 and FIG. 4, the middle portion of the spider 6 is provided with a center hole 62 for exposing the magnetic gap 51 and an inner edge 63 surrounding the center hole 62, and the inner edge 63 of the spider 6 is connected to the frame 1. Specifically, the magnetic drive unit 5 comprises a magnetically conductive U-yoke 52, and a magnetic steel 53 and a front panel 54 arranged within the U-yoke 52, the magnetic gap 51 is formed between an inner side surface of the U-yoke 52 and outer side surfaces of the magnetic steel 53 and the front panel 54, and the voice coil 4 is inserted into the magnetic gap 51 after passing through the center hole 62. The magnetic steel 53 can be a permanent magnet. Further, the frame 1 has a cylindrical portion 11 surrounding the U-yoke 52, and the spider 6 is fixedly connected to the cylindrical portion 11 of the frame 1. Specifically in this embodiment, the spider 6 is bonded to the cylindrical portion 11 via glue. Specifically, referring to FIG. 3, the U-yoke 52 comprises a top panel and a circle of side panel extending downwards from the edge of the top panel, thereby enclosing the mounting cavity; the magnetic steel 53 and the front panel 54 are stacked on top and bottom inside the mounting cavity. Wherein, the upper surface of the magnetic steel 53 is fixedly connected to the top panel of the U-yoke 52, for example, through bonding via glue; the upper surface of the front panel 54 is fixedly connected to the lower surface of the magnetic steel 53, for example, through bonding via glue. In addition, the middle of the top panel of U-yoke 52 protrudes downwards. The above-mentioned magnetic gap 51 is formed between the inner surface of the side panel of U-yoke 52, the outer circumferential surface of the magnetic steel 53, and the outer circumferential surface of the front panel 54; when viewed from above, the magnetic gap 51 appears as a circular ring. The middle portion of the upper surface of the top of the U-yoke 52 has a groove recessed downward; and a through hole is provided in the middle portion of the front panel 54.

The cone 2 comprises a conical body 23 with a truncated conical shape, and the inner end portion 22 is located at the cone top of the conical body 23. Specifically, the inner end portion 22 is a voice coil mounting hole located at the cone top, and the voice coil 4 passes through the voice coil mounting hole and is bonded to the hole wall of the voice coil mounting hole. The outer end portion 21 of the cone 2 comprises a yoke ring 211 connected to the cone bottom of the conical body 23, and the yoke ring 211 is fixedly connected to the frame 1. The conical body 23 is formed by enclosing sheet-like materials (such as paper, PP plastic sheets); the yoke ring 211 surrounds the outer end portion of the conical body 23 and fixes the conical body 23 to the frame 1, for example, through bonding via glue.

After the voice coil 4 is powered on, due to electromagnetic induction, the voice coil 4 can undergo longitudinal reciprocating motion, that is, the voice coil 4 will vibrate up and down, the voice coil 4 and the inner end portion 22 of the cone 2 are closely fitted, so the voice coil 4 will drive the cone 2 to vibrate up and down. The voice coil 4 in this embodiment is less prone to left and right shaking due to the bonding between the inner edge 63 of the spider 6 and the cylindrical portion 11 of the frame 1, and due to the outer edge 61 of the spider 6 is fixedly connected to the cone 2, the voice coil 4 can reduce the shaking in the horizontal direction, and substantially vibrate up and down, thereby avoiding any impact on the sound quality.

Referring FIG. 1 and FIG. 3, the voice coil 4 has a lead connecting portion 41 that passes through the voice coil mounting hole to the outside of the cone 2, the voice coil 4 has two leads 42, with one end of each lead 42 connected to the lead connecting portion 41. The frame 1 is provided with a wiring terminal 12, the wiring terminal 12 comprises soldering lugs 121 embedded in the frame 1, and the other end of each lead 42 is electrically connected to one of the soldering lugs 121. The wiring terminal 12 can be connected to a power amplifier or other devices through a cable to receive an audio signal transmitted to the voice coil 4 through the leads 42, which vibrates under the action of the magnetic drive unit 5, undergoes electroacoustic conversion, and drives the cone 2 to vibrate and produce sound. The leads 42 specifically adopt braided wires. Further, the wiring of the leads 42 in this embodiment is independent of the spider 6, and does not need to pass through the spider 6, simplifying assembly and manufacturing.

The voice coil 4 is provided with a plurality of through holes 43, to play a role in heat dissipation. The plurality of through holes 43 are spaced along the circumferential direction of the voice coil 4; the position of the through holes 43 is lower than that of the spider 6. A part of the voice coil 4 protrudes outside the cone 2, and the inverted loudspeaker further comprises a dustproof cover 7 for covering the voice coil 4, for preventing dusts entering the interior of the loudspeaker.

As shown in FIG. 1, the frame 1 comprises a main body 13 and a skirt edge portion 14 that is bent and extended from an outer edge of the main body 13, the cone 2 is located in the space enclosed by the main body 13 and the skirt edge portion 14, and the wiring terminal 12 is located on the skirt edge portion 14. The main body 13 is provided with a plurality of hollowed-out portions 131, the hollowed-out portions 131 can reduce the weight of the frame 1 and also facilitate heat dissipation. The frame 1 has both protective and supportive functions. Specifically, the main body 13 is mainly composed of the above-mentioned cylindrical body 11 and a plurality of connecting ribs. The plurality of connecting ribs are spaced along the circumference of the cylindrical body 11, and each connecting rib extends outward along the diameter direction of the cylindrical body. Each connecting portion gradually tilts upwards from its inner end to its outer end, and the above-mentioned hollowed-out portions 131 are formed between every adjacent connecting ribs.

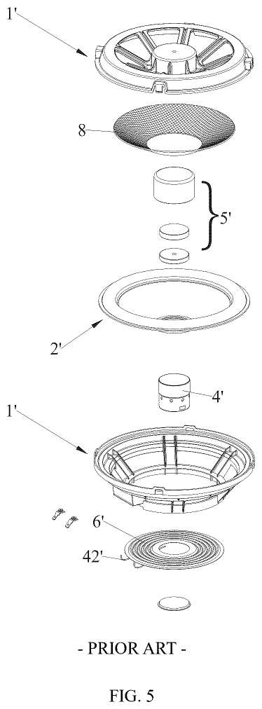

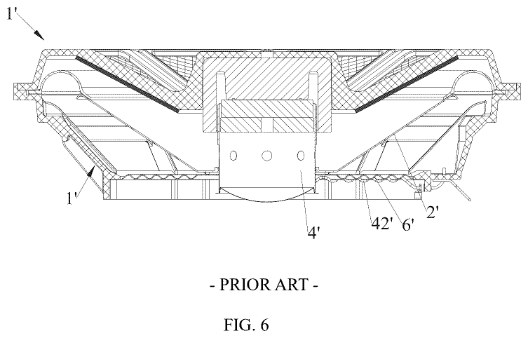

This embodiment further provides an vehicle audio system comprising the inverted loudspeaker mentioned above. Further, the inverted loudspeaker is mounted in the door of vehicle, and serves as a door loudspeaker. Comparing with the vehicle loudspeaker shown in FIG. 5 and FIG. 6, the spider is located outside the magnetic drive unit and the cone; while in the inverted loudspeaker of the this embodiment, the outer edge of the spider is bonded to the inner surface of the conical body of the cone, to form a structure where the spider is located between the cone and the magnetic drive unit, thereby reducing the overall height of the loudspeaker and making it more suitable for installation needs of some flat and narrow space structures, and meanwhile saving space for vehicle door panels.

Moreover, in addition to reducing the overall height of the loudspeaker and occupying less space, this embodiment further has at least four advantages. (1) The spider is connected to the frame and bonded together with the frame to achieve better dust prevention effect, and comparing with the inverted loudspeaker shown in FIG. 5 and FIG. 6, the loudspeaker of this embodiment does not need to provide a dust-proof cover 8′ and one extra frame 1′. (2) Comparing with the inverted loudspeaker shown in FIG. 5 and FIG. 6, where the spider and the leads are integrally bonded, the leads need to pass through the spider, resulting in high assembly and processing costs, however in this embodiment, the spider and the leads are independent and separate, making the manufacturing process simpler and more cost-effective. (3) In this embodiment, the spider is fixedly connected to the frame, and the outer edge of the spider is connected to the cone, such that the voice coil is less prone to left and right shaking, thereby avoiding any impact on the sound quality. (4) The magnetic drive unit and the spider are located between the cone and the frame, and the voice coil is substantially inside the frame without being exposed to prevent collision, and the internal components such as the cone and the voice coil can be well protected.

Those skilled in the art can understand that unless specifically stated, the singular forms “a”, “said”, and “the” used herein may also include the plural form.

As shown in the description and claims of the present disclosure, the terms “comprising” and “containing” only indicate that the clearly identified steps and elements are included, and these steps and elements do not constitute an exclusive list, and the method or device may also include other steps or elements. The term “and/or” as used herein includes any combination of one or more of the associated listed items.

It should be further understood that in the present disclosure, “a plurality of” refers to two or more, and other quantifiers are similar. “And/or” describes the association relationship of the associated objects, indicating that there can be three types of relationships, for example, A and/or B, which can represent: the existence of A alone, the coexistence of A and B, and the existence of B alone.

In this embodiment, unless otherwise expressly specified and limited, a first feature being “on” or “under” a second feature may include direct contact between the first feature and the second feature, as well as contact between the first feature and the second feature through an intermediate medium between them rather than direct contact. Also, the first feature being “on”, “above”, or “over” the second feature includes that the first feature is directly above or obliquely above the second feature, or simply means that the first feature is level higher than the second feature. The first feature being “under”, “below” or “underneath” the second feature includes that the first feature is directly below or obliquely below the second feature, or simply means that the first feature has a lower level than the second feature.

The embodiments described above are only for illustrating the technical concepts and features of the present disclosure, are preferred embodiments, and are intended to make those skilled in the art being able to understand the present disclosure and thereby implement it, and should not be concluded to limit the protective scope of this disclosure.

1. A loudspeaker, comprising:
a frame;
a cone having an outer end portion and an inner end portion that are open and opposite to each other, the frame being covered on the outer end portion of the cone, and the outer end portion being connected to the frame;
a voice coil connected to the inner end portion of the cone;
a magnetic drive unit to drive the voice coil to vibrate, the magnetic drive unit being arranged on the frame, the magnetic drive unit having a magnetic gap, and a part of the voice coil being inserted into the magnetic gap; and
a spider arranged between the frame and the cone, and an outer edge of the spider being connected to the cone.

2. The loudspeaker of claim 1, wherein a center hole for exposing the magnetic gap is provided on a middle portion of the spider, and
wherein an inner edge surrounding the center hole of the spider is connected to the frame.

3. The loudspeaker of claim 2, wherein the magnetic drive unit comprises a U-yoke, a magnetic steel, and a front panel arranged within the U-yoke,
wherein the magnetic gap is formed between an inner side surface of the U-yoke and outer side surfaces of the magnetic steel and the front panel, and
wherein the voice coil passes through the center hole and inserts into the magnetic gap.

4. The loudspeaker of claim 3, wherein the frame has a cylindrical portion surrounding the U-yoke, and
wherein the inner edge of the spider is fixedly connected to the cylindrical portion of the frame.

5. The loudspeaker of claim 4, wherein the inner edge of the spider is bonded to the cylindrical portion of the frame via glue.

6. The loudspeaker of claim 1, wherein the cone comprises a conical body with a truncated conical shape, and the inner end portion is located at a cone top of the conical body,
wherein the outer end portion comprises a yoke ring connected to a cone bottom of the conical body, the yoke ring fixedly connected to the frame, and
wherein the outer edge of the spider is fixedly connected to an inner surface of the conical body.

7. The loudspeaker of claim 6, wherein the inner end portion is a voice coil mounting hole located at the cone top, and
wherein the voice coil passes through the voice coil mounting hole and is bonded to a hole wall of the voice coil mounting hole.

8. The loudspeaker of claim 7, wherein the voice coil has a lead connecting portion that passes through the voice coil mounting hole to an outside of the cone, and
wherein ends of leads of the voice coil are connected to the lead connecting portion.

9. The loudspeaker of claim 8, wherein a wiring terminal is arranged on the frame,
wherein the wiring terminal comprises soldering lugs embedded in the frame, and
wherein the other ends of the leads are electrically connected to the soldering lugs respectively.

10. The loudspeaker of claim 6, wherein the outer edge of the spider is bonded to the inner surface of the conical body via glue.

11. The loudspeaker of claim 1, wherein a part of the voice coil protrudes outside the cone, and
wherein the loudspeaker further comprises a dustproof cover for covering the part of the voice coil protruding outside the cone.

12. The loudspeaker of claim 1, wherein the frame comprises a main body and a skirt edge portion that is bent and extended from an outer edge of the main body,
wherein the cone is located in a space enclosed by the main body and the skirt edge portion, and
wherein the main body is provided with a plurality of hollowed-out portions.

13. The loudspeaker of claim 12, wherein the skirt edge portion is provided with a wiring terminal, and
wherein leads of the voice coil have inner end portions connected to the voice coil and outer end portions connected to the wiring terminal.

14. The loudspeaker of claim 1, wherein the voice coil is provided with a plurality of through holes.

15. A vehicle audio system comprising the loudspeaker of claim 1.
